(19) United States
(12) Patent Application Publication
(10) Pub. No.: US 2007/0047731 A1
(43) Pub. Date: Mar. 1, 2007

(54) Clipping detector for echo cancellation

(75) Inventor: Charles A. Lipari III, Tempe, AZ (US)

Correspondence Address: Paul F. Wille, 6407 East Clinton St., Scottsdale, AZ, 85254, US

(73) Assignee: Acoustic Technologies, Inc., Mesa, AZ (US)

(21) Appl. No.: 11/216,284

(22) Filed: Aug. 31, 2005

(51) Int. Cl. H04M 9/08

(52) U.S. Cl. 379/406.01

(57) ABSTRACT

An adaptive filter in an echo canceling circuit includes a clipping detector that affects the coefficients of the adaptive filter when clipping is detected. Clipping is defined as at least two successive maxima or minima in a predetermined period. The coefficients are either locked or the echo estimate is reduced to prevent overcorrection. In accordance with another aspect of the invention, lower order bits are ignored to avoid problems of bit resolution when comparing signals.

### BACKGROUND OF THE INVENTION

This invention relates to a telephone employing echo canceling circuitry and, in particular, to echo canceling circuitry that includes a clipping detector.

As used herein, “telephone” is a generic term for a communication device that utilizes, directly or indirectly, a dial tone from a licensed service provider. As such, “telephone” includes desk telephones (see FIG. 1), cordless telephones (see FIG. 2), speaker phones (see FIG. 3), hands free kits (see FIG. 4), and cellular telephones (see FIG. 5), among others. For the sake of simplicity, the invention is described in the context of telephones but has broader utility; e.g. communication devices that do not utilize a dial tone, such as radio frequency transceivers.

There are two kinds of echo in a telephone system, an acoustic echo between an earphone or a loudspeaker and a microphone and electrical echo generated in the switched network for routing a call between stations. In a handset, acoustic echo is typically not much of a problem. In speaker phones, where several people huddle around a microphone'and loudspeaker, acoustic feedback is much more of a problem. Hybrid circuits (two-wire to four-wire transformers) located at terminal exchanges or in remote subscriber stages of a fixed network are the principal sources of electrical echo.

One way to reduce echo is to program the frequency and phase response of a filter to match the frequency and phase response of an echo path. A filter typically used is a finite impulse response (FIR) filter having programmable coefficients. A filtered signal, emulating the echo, is subtracted from the echo bearing signal at an input. This technique reduces echo typically as much as 30 dB, depending upon the coefficient adaptation algorithm. Additional means using non-linear techniques are typically added to further reduce an echo. Approximating a solution for an adaptive filter is like trying clothes on a squirming child: the input signal keeps changing. At one extreme, sudden and/or large changes can upset the approximation process and make the process diverge rather than converge. At the other extreme, a low echo to noise ratio can cause instability and divergence.

As if variations in the input signal were not enough, errors within the audio processing portion of a telephone can compound the problem of convergence. The audio processing circuit contains two channels. A transmit channel extends from a microphone input to a line output. A receive channel extends from a line input to a speaker output. The transmit channel contains several stages, each with its own gain, that can cause the signal to exceed the dynamic range of the analog components or the digital componoents in a stage. Exceeding the range of a stage “saturates” the stage and causes the signal to become “clipped.” Portions of the signal are lost.

When a signal is in analog form, the voltage increases to a maximum and goes no higher. When a signal is in digital form, a stage saturates by having the digital value representing the signal be larger than the capacity of a register. For example, a one byte (eight bit) register can store signed values in the range 0 to 127 (one bit indicates sign, + or −). Any data larger than 127 causes the register to “overflow” and data lower than −127 causes the register to “underflow”. Carefully written software usually includes routines to check for and prevent overflow and underflow, whether the values are signed or unsigned. Thus, the data is set to some number, e.g. the range of the register, and the signal is clipped to its minimum value or to its maximum value.

Stages following the clipping stage may have an even lower saturation level than the maximum allowable range of the signal of a preceding stage. Analog stages may saturate at a different level from digital stages and vice-versa. Often stages are provided with variable gains to perform certain functions. Thus, clipping does not necessarily occur at a given stage and may not occur at all under benign operating conditions. Clipping is a type of nonlinearity that cannot be canceled by a typical FIR filter used in an echo canceling circuit.

There can be two kinds of clipping in an audio processing circuit. The kind described above is undesirable. There is also what is known as center clipping, typically combined with other circuits in what is known as the non-linear processing portion of an echo canceling circuit. In center clipping, low level signals (signals near zero crossing, which is why it is called “center” clipping) are removed or clipped. The theory is that low level signals are not voice but echo or noise. Thus, for example, digital data in the range ±5 is set to zero. Data outside the range ±5 is passed to the following stage unaltered. Analog signals can be processed in the same way; e.g. see FIG. 2 of U.S. Pat. No. 4,282,411 (Stewart). This invention has nothing to do with center clipping, except that it is compatible with such circuits; i.e. the clipping detector of the invention is unaffected by, and has no effect on, center clipping circuits.

In the prior art, U.S. Pat. No. 6,650,701 (Hsiang et al.) discloses an echo canceling system that checks for distortion at a microphone input, wherein distortion is defined as exceeding an amplitude threshold. U.S. Pat. No. 6,771,771 (Moon et al.) discloses using a variable gain amplifier on a microphone input to prevent overloading an analog to digital (A/D) converter.

In view of the foregoing, it is therefore an object of the invention to provide a clipping detector for improving acoustic echo canceling in a telephone.

Another object of the invention is to provide a clipping detector for improving the stability of an acoustic echo canceling circuit.

### SUMMARY OF THE INVENTION

The foregoing objects are achieved in this invention in which an adaptive filter in an echo canceling circuit includes a clipping detector that affects the coefficients of the adaptive filter when clipping is detected. Clipping is defined as at least two successive maxima or minima in a predetermined period. The coefficients are either locked or the echo estimate is reduced to prevent overcorrection. In accordance with another aspect of the invention, lower order bits are ignored to avoid problems of bit resolution when comparing signals.

### BRIEF DESCRIPTION OF THE DRAWINGS

A more complete understanding of the invention can be obtained by considering the following detailed description in conjunction with the accompanying drawings, in which:

FIG. 1 is a perspective view of a desk telephone;

FIG. 2 is a perspective view of a cordless telephone;

FIG. 3 is a perspective view of a conference phone or a speaker phone;

FIG. 4 is a perspective view of a hands free kit;

FIG. 5 is a perspective view of a cellular telephone;

FIG. 6 is a generic block diagram of audio processing circuitry in a telephone;

FIG. 7 is a more detailed block diagram of audio processing circuitry in a telephone;

FIG. 8 is a block diagram of an acoustic echo canceler constructed in accordance with the invention; and

FIG. 9 is a block diagram of a clipping detector constructed in accordance with a preferred embodiment of the invention.

Those of skill in the art recognize that, once an analog signal is converted to digital form, all subsequent operations can take place in one or more suitably programmed microprocessors. Reference to “signal”, for example, does not necessarily mean a hardware implementation or an analog signal. Data in memory, even a single bit, can be a signal. In other words, a block diagram can be interpreted as hardware, software, e.g. a flow chart or an algorithm, or a mixture of hardware and software. Programming a microprocessor is well within the ability of those of ordinary skill in the art, either individually or in groups.

### DETAILED DESCRIPTION OF THE INVENTION

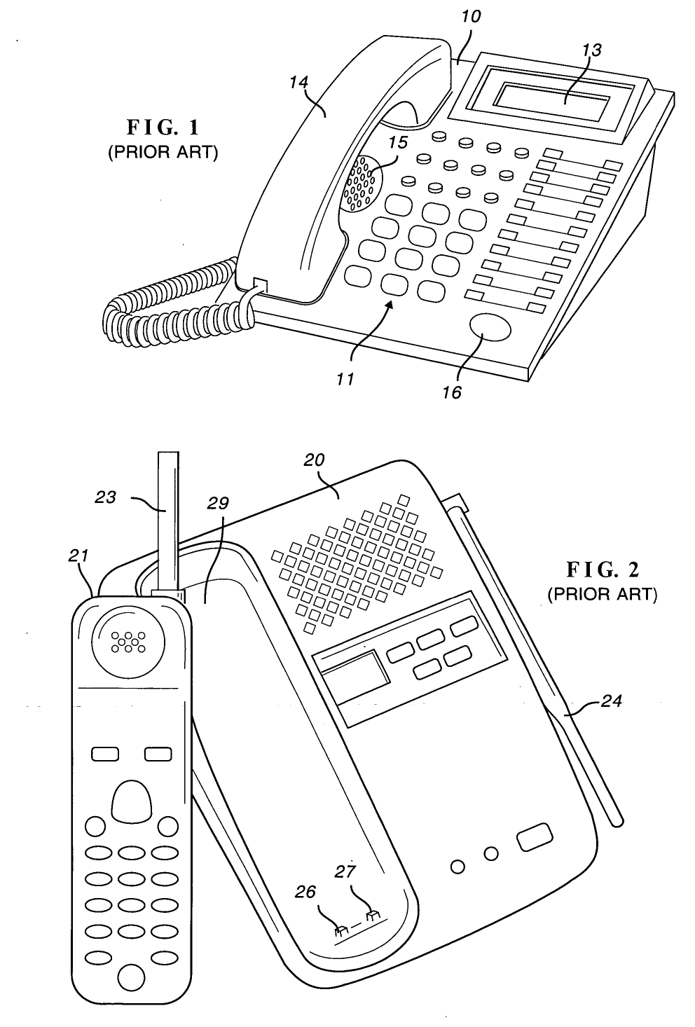

This invention finds use in many applications where the electronics is essentially the same but the external appearance of the device may vary. FIG. 1 illustrates a desk telephone including base 10, keypad 11, display 13 and handset 14. As illustrated in FIG. 1, the telephone has speaker phone capability including speaker 15 and microphone 16. The cordless telephone illustrated in FIG. 2 is similar except that base 20 and handset 21 are coupled by radio frequency signals, instead of a cord, through antennas 23 and 24. Power for handset 21 is supplied by internal batteries (not shown) charged through terminals 26 and 27 in base 20 when the handset rests in cradle 29.

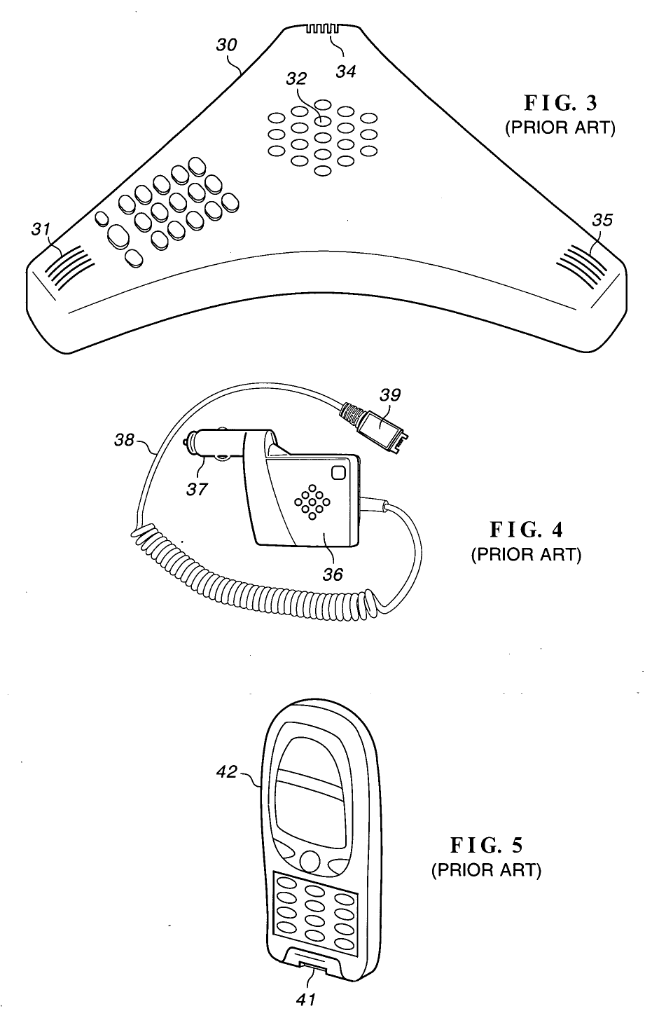

FIG. 3 illustrates a conference phone or speaker phone such as found in business offices. Telephone 30 includes microphone 31 and speaker 32 in a sculptured case. Telephone 30 may include several microphones, such as microphones 34 and 35 to improve voice reception or to provide several inputs for echo rejection or noise rejection, as disclosed in U.S. Pat. No. 5,138,651 (Sudo).

FIG. 4 illustrates what is known as a hands free kit for providing audio coupling to a cellular telephone, illustrated in FIG. 5. Hands free kits come in a variety of implementations but generally include powered speaker 36 attached to plug 37, which fits an accessory outlet or a cigarette lighter socket in a vehicle. A hands free kit also includes cable 38 terminating in plug 39. Plug 39 fits the headset socket on a cellular telephone, such as socket 41 (FIG. 5) in cellular telephone 42. Some kits use RF signals, like a cordless phone, to couple to a telephone. A hands free kit also typically includes a volume control and some control switches, e.g. for going “off hook” to answer a call. A hands free kit also typically includes a visor microphone (not shown) that plugs into the kit. Audio processing circuitry constructed in accordance with the invention can be included in a hands free kit or in a cellular telephone.

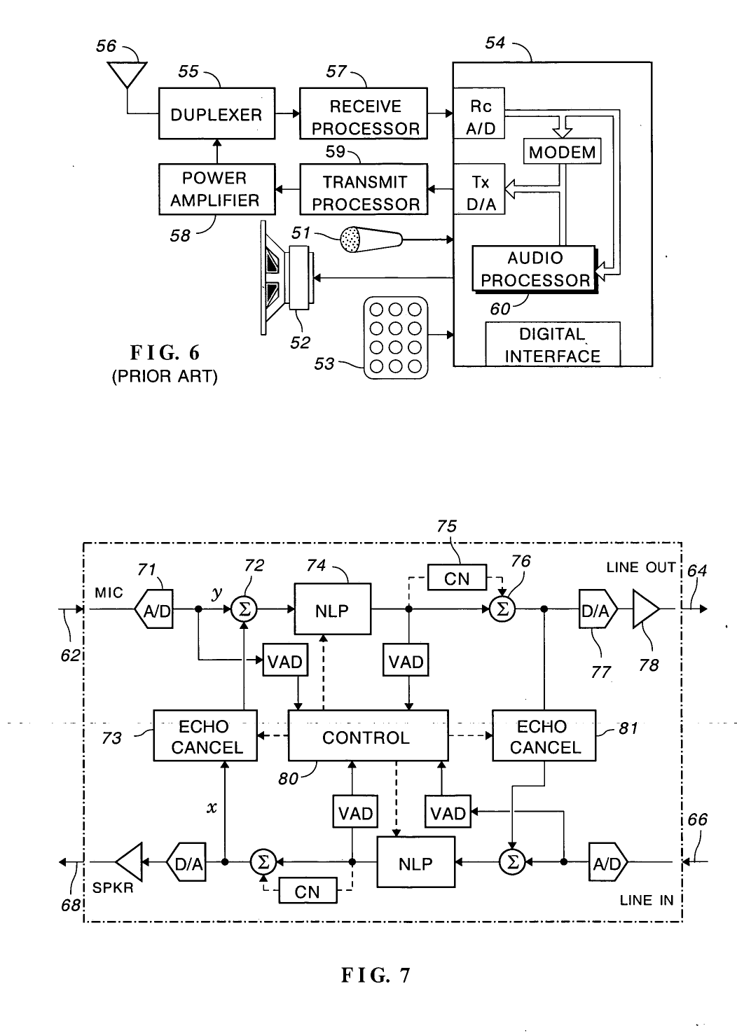

The various forms of telephone can all benefit from the invention. FIG. 6 is a block diagram of the major components of a cellular telephone. Typically, the blocks correspond to integrated circuits implementing the indicated function. Microphone 51, speaker 52, and keypad, 53 are coupled to signal processing circuit 54. Circuit 54 performs a plurality of functions and is known by several names in the art, differing by manufacturer. For example, Infineon calls circuit 54 a “single chip baseband IC.” QualComm calls circuit 54 a “mobile station modem.” The circuits from different manufacturers obviously differ in detail but, in general, the indicated functions are included.

A cellular telephone includes both audio frequency and radio frequency circuits. Duplexer 55 couples antenna 56 to receive processor 57. Duplexer 55 couples antenna 56 to power amplifier 58 and isolates receive processor 57 from the power amplifier during transmission. Transmit processor 59 modulates a radio frequency signal with an audio signal from circuit 54. In non-cellular applications, such as speakerphones, there are no radio frequency circuits and signal processor 54 may be simplified somewhat. Problems of echo cancellation and noise remain and are handled in audio processor 60. It is audio processor 60 that is modified to include the invention. How that modification takes place is more easily understood by considering the echo canceling and noise reduction portions of an audio processor in more detail.

FIG. 7 is a detailed block diagram of a noise reduction and echo canceling circuit; e.g. see chapter 6 of Digital Signal Processing in Telecommunications by Shenoi, Prentice-Hall, 1995, with the addition of four VAD circuits as disclosed in U.S. Pat. 6,754,337 (Domer et al.). The following describes signal flow through the transmit channel, from microphone input 62 to line output 64. The receive channel, from line input 66 to speaker output 68, works in the same way, except that the gain of a particular stage may be different from the gain of a corresponding stage in the transmit channel. A new voice signal entering microphone input 62 may or may not be accompanied by a signal from speaker output 68. The signals from input 62 are digitized in A/D converter 71 and coupled to summation network 72. There is, as yet, no signal from echo canceling circuit 73 and the data proceeds to non-linear processing circuit 74, which includes a noise reduction circuit, a residual echo cancelling circuit, and a center clipper connected between the input and output thereof.

The output from non-linear processing circuit 74 is coupled to summation circuit 76, where comfort noise 75 is optionally added to the signal. The signal is then converted back to analog form by D/A converter 77, amplified in amplifier 78, and coupled to line output 64. Data from the four VAD circuits is supplied to control 80, which uses the data for allocating sub-bands, echo elimination, and other functions. Circuit 73 reduces acoustic echo and circuit 81 reduces line echo. The operation of these last two circuits is known per se in the art; e.g. as described in the above-identified text.

The path from speaker output 68 to microphone input 62 is simulated in echo canceler 73 by operation on signal x from the receive channel. In the simple case where there is no echo, signal x is attenuated and no signal is subtracted from signal y in circuit 72. In the more complex case where there is echo, echo canceler 73 simulates the attenuation, frequency response, and phase (delay) of the path for subtracting the echo from the signal at microphone input 62.

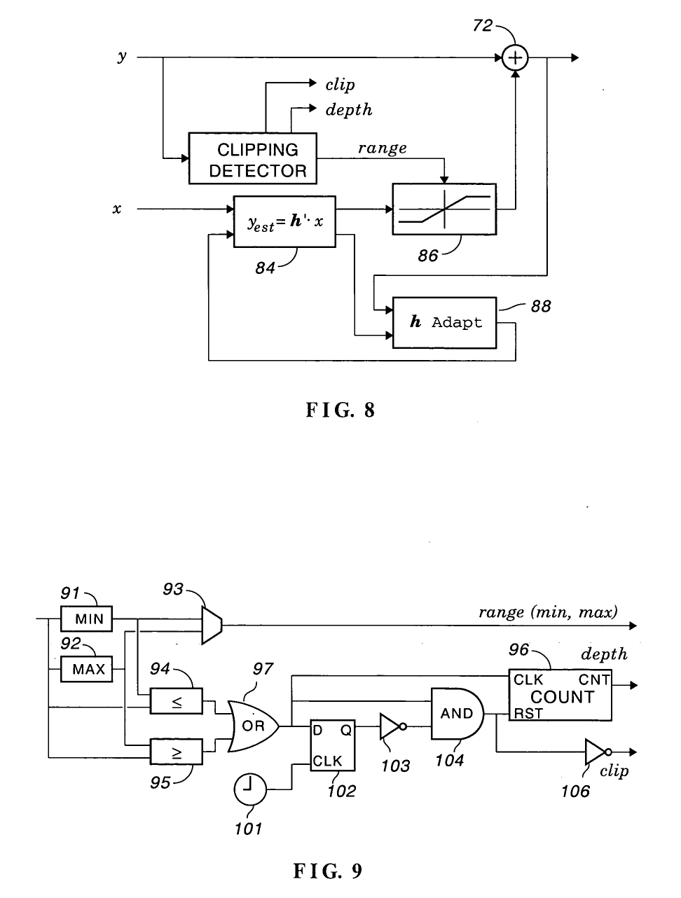

The external path can be simulated with any linear filter, such as an FIR filter known in the art. The basic operation of an echo canceler constructed in accordance with the invention is illustrated in FIG. 8. Linear filter 84 operates on signal x from the receive channel to produce an estimate of the echo that is subtracted from input signal y in summation circuit 72. In accordance with the invention, the estimate is adjusted for the range of clipping in circuit 86, which adjusts the estimate to remain within the dynamic range of the microphone input. The range signal is obtained from clipping detector 89, which is also coupled to input signal y.

As described in greater detail in conjunction with FIG. 9, range is sensed by observing flat spots in the speech (echo plus noise) input. Successive maximum or minimum values of the signal indicates clipping. The number of successive values is not critical. Feedback circuit 88 compares the output from summation circuit 72 with the estimate to change coefficients as necessary for imitating the echo path. Circuit 86 adjusts amplitude and circuit 88 adjusts frequency response and phase for the simulated echo path through filter 84.

FIG. 9 is a block diagram of clipping detector 90, constructed in accordance with a preferred embodiment of the invention. Clipping detector 90 provides signals representing clipping range, clipping depth, and a binary signal indicating that clipping is occurring. The maximum value and minimum value are tracked over the full length of an input sample by detectors 91 and 92, respectively, and combined to make the range signal in logic 93. These values are inaccurate until saturation (clipping) occurs. Clipping is detected as repeated values of the input at the current maximum or minimum levels. The range output signal gives the maximum and minimum values used for clipping the echo estimate from filter 84. The clip signal is a system signal to indicate that clipping has occurred. The depth signal, the length of the clipping or the number of successive maxima or minima, is available to the audio processing circuit for further gain adjustment, if desired.

Analog clipping may generate values that do not repeat because of filtering and the resolution of the A/D converter. The “≧” and “≦” symbols in comparators 94 and 95 represent a comparison of higher order bits. In other words, the output is “true” or a logic one when the difference between one input and the other is less than 1 bit or less than 2 bits of resolution. A repeated maximum or minimum value is signaled as a clip. For example, in binary notation, a maximum of 11101101 and a maximum of 11101110 match if the two lower order (right hand) bits are ignored. Thus, the second data is considered a repeated maximum, indicating clipping. The number of bits one chooses to ignore is arbitrary. Ignoring the 0 and 1 bits has been found satisfactory. Ignoring more (higher order) bits can lead to false positives, which are more undesirable than false negatives. The repeats are usually either maxima or minima. In fact, it is very unlikely for a maximum to be followed by a minimum, or vice-versa.

Also of interest is the depth of the clipping, defined as the number of successive maximums or minimums. The number gives some idea of how much the microphone signal is being clipped. Each maximum, or minimum, increments counter 96 through OR-gate 97. The count is accumulated during a sample period determined by clock 101, D-flip-flop 102, inverter 103, and AND gate 104. A logic one output from AND gate 104 resets counter 96. The output from AND gate 104 is inverted by inverter 106 to provide a binary indication of clipping.

The range data is used to modify the echo estimate using range limiting circuit in circuit 86. In the event of a large amount of clipping, the estimate is locked to prevent the adaptation loop from diverging. Other portions of the echo canceling circuitry (not shown) can remain in operation, e.g. attenuation and center-clipping.

The invention thus provides a clipping detector for improving acoustic echo canceling in a telephone and, in particular, for improving the stability of an acoustic echo canceling circuit using a linear filter. The invention enables an echo cancelling circuit to operate even when the input has been clipped within the range allowed by the echo cancelling algorithm.

Having thus described the invention, it will be apparent to those of skill in the art that various modifications can be made within the scope of the invention. For example, circuits 72 and 76 (FIG. 7) are called “summation” circuits with the understanding that a simple arithmetic process is being carried out, which can be either digital or analog, whether the process entails actually subtracting one signal from another signal or inverting (changing the sign of) one signal and then adding it to another signal. Stated another way, “summation” is defined herein as generic to addition and subtraction. The depth of clipping is estimated by counting the number of repeated maximums or minimums. The count value gives a heuristic estimate of how much of the signals is being clipped. Interpolation of the clipped values would give a more accurate estimate, but this would require more processing (band-limited interpolation filter over the missing samples). D-flip-flop 102 acts as a single stage counter, requiring that there be two maxima or minima for the output of inverter 106 to go true. A counter of greater capacity could be substituted, requiring more than two successive maxima or minima for an indication of clipping. While echo canceling can continue in a system constructed in accordance with the invention, one can use the available signals to provide alternative modes of operation. For example, the,depth signal can be used to shut off echo canceling if the clipping exceeds some threshold. In other words, just because an echo canceler constructed in accordance with the invention can continue to operate does not mean that it has to continue. Similarly, the clip signal can cause an preset change in gain in one or more stages of the audio processing circuit. This preset change in gain, combined with the adjustment caused by the range signal, increases the dynamic range of the circuit.

What is claimed as the invention is:

1. In a telephone including an audio frequency circuit having a transmit channel, a receive channel, and at least one echo canceling circuit coupled between said channels, the improvement comprising:
an adaptive filter in said echo canceling circuit; and
a circuit coupled to said adaptive filter for changing coefficients in said adaptive filter, wherein said circuit includes a clipping detector.

2. The telephone as set forth in claim 1 wherein said clipping detector includes a counter for counting consecutive maxima or minima of a signal, wherein the count in said counter affects the coefficients of said adaptive filter.

3. The telephone as set forth in claim 2 where said count affects the coefficients by temporarily locking the coefficients.

4. The telephone as set forth in claim 2 where said count affects the coefficients by setting the coefficients to a predetermined value.

5. The telephone as set forth in claim 4 where said count affects the coefficients by temporarily locking the coefficients.

6. The telephone as set forth in claim 2 wherein said signal is in digital form, including a number of binary bits, wherein at least the lowest order bit is ignored when evaluating said signal.

7. The telephone as set forth in claim 2 wherein a count equal to or greater than two indicates clipping.

8. The telephone as set forth in claim 1 wherein said clipping detector includes:
a first circuit for detecting the maximum amplitude of a signal;
a second circuit for detecting the minimum amplitude of a signal;
logic for combining data representing the minimum amplitude and the maximum amplitude to provide range data;
wherein said range data affects the coefficients of said adaptive filter.

9. In a telephone including an audio frequency circuit having a transmit channel, a receive channel, and at least one echo canceling circuit coupled between said channels, the improvement comprising:
a clipping detector coupled to said echo canceling circuit, said clipping detector enabling the echo canceling circuit to operate on a signal outside the dynamic range of a channel.

10. The telephone as set forth in claim 9 wherein said echo canceling circuit is implemented in software and the clipping detector enables the echo canceling circuit to operate on a signal clipped below the dynamic range allowed by the echo canceling algorithm.
